(19) United States
(12) Patent Application Publication
(10) Pub. No.: US 2003/0120773 A1
(43) Pub. Date: Jun. 26, 2003

(54) Method for monitoring quality of service in a packet-oriented network

(75) Inventors: Harald Mueller, Gilching (DE); Juergen Totzke, Poing (DE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/324,119

(22) Filed: Dec. 20, 2002

(30) Foreign Application Priority Data
Dec. 21, 2001 (DE) 101 63 530.3

(51) Int. Cl. G06F 15/173

(52) U.S. Cl. 709/224

(57) ABSTRACT

To monitor the quality of service in a packet-oriented network, measurement data on the quality of service of a connection is collected by an endpoint of the connection within a given time interval. The measurement data is then sent for subsequent processing to a registration unit specifically responsible for connections with the endpoint.

### CROSS REFERENCE TO RELATED APPLICATIONS

This application is based on and hereby claims priority to German Application No. 101 63 530.3 filed on Dec. 21, 2001, the contents of which are hereby incorporated by reference.

### BACKGROUND OF THE INVENTION

A major problem with modern Voice/Video over Internet Protocol (VoIP) and Multimedia over Internet Protocol (MoIP) communication systems is providing a quality of service (QoS) required for realtime communication in the communication network used to transport data packets. A QoS guarantee is made all the more difficult because infrastructure, configuration and load characteristics of Internet Protocol (IP) communication networks are highly dynamic.

To ensure correct operation of a VoIP/MoIP system the following development steps are generally required:

Network analysis of existing networks,

Planning and dimensioning of the VoIP/MoIP network (including connectivity, bandwidth, routing),

Dimensioning of VoIP/MoIP service classes, e.g. differentiated by transmission bandwidth,

Adaptation of the existing networks when input parameters have changed, e.g. more subscribers, new applications, changed traffic patterns, and

Network monitoring of the engineered VoIP/MoIP system in order to check compliance with the planning target under real conditions.

Network monitoring is becoming more and more important in this connection, since theoretical input parameters for data traffic planning tend to grow increasingly complex and less predictable. Network monitoring is generally performed using network probes which measure specified QoS parameters, such as delay, jitter or packet losses of the IP network or specific applications.

The results of network monitoring can in particular be used to:

monitor the proper operation of VoIP/MoIP applications,

detect and localize errors and performance degradations, and

re-engineer the network (e.g. as regards network topology, adding routes, bandwidth, modifying service classes).

When a VoIP/MoIP communication network is deployed, a network analysis normally takes place in advance using dedicated network probes, in order to determine whether or not the existing IP network infrastructure is suitable for realtime communication. The network probes have to be connected at different places to the existing communication network. However, this is generally very costly and time-consuming and is moreover also associated with security risks.

A communication network is regarded as suitable for realtime communication if certain QoS thresholds, e.g. as regards end-to-end packet delay or packet losses, are not exceeded. But even if a network infrastructure proves to be suitable for realtime communication at the time of deployment, this may change afterwards. In such a case a costly and time-consuming network analysis based on network probes has to be repeated.

### SUMMARY OF THE INVENTION

It is an object of the present invention to specify a less costly and time-consuming procedure for QoS monitoring in a packet-oriented network.

For QoS monitoring in a packet-oriented network, measurement data on the QoS of a connection is collected by an endpoint of the connection within a given time interval. Such a connection endpoint can for instance be an IP telephone, a VoIP client or what is known as an IP gateway. The measurement data is sent for subsequent processing to a registration unit specifically responsible for connections with the endpoint, e.g. to what is known as a gatekeeper or a registrar.

A major advantage of the invention is that existing communication components—e.g. VoIP/MoIP terminals, gatekeepers or registrars—can be used for QoS monitoring. To this end, corresponding monitoring components can be integrated into potential connection endpoints. The measurements can be performed by the connection endpoints during their normal operation. No additional network probes are required. In addition, the network can be fully covered by measurements, i.e. in all areas accessible for connections, which is not possible using network probes deployed on a localized basis according to the prior art.

According to an advantageous embodiment of the invention current QoS measurement data can be sent at regular intervals from the endpoint to the registration unit. The intervals can be specified by a Registration Access Status—Admission Confirm (RAS-ACF) message in accordance with ITU-T Recommendation H.225.

Preferably existing messages can be enhanced in order to send the QoS measurement data. Thus particularly in communication systems in accordance with ITU-T Recommendation H.323 the measurement data within a Registration Access Status Information Request Response (RAS-IRR) message enhanced with a specific information element can be sent in accordance with ITU-T Recommendation H.225. Preferably such an enhanced RAS-IRR message can be sent periodically after it is requested by an RAS-ACF message. Furthermore, when the connection is cleared down, the measurement data can be sent in an Registration Access Status—Disengage Request (RAS-DRQ) message enhanced with a specific information element in accordance with ITU-T Recommendation H.225.

In an advantageous development of the invention the registration unit can process the received measurement data to form a connection-specific QoS data record and send the QoS data record to a central postprocessing device for evaluation. Preferably the QoS data record can be sent with a billing data record, provided anyway for billing purposes, enhanced by a QoS information element, e.g. a call detail record or CDR data record. The connection is then billed on the basis of the billing data record dependent on a QoS data record contained therein.

Preferably the measurement data can be determined in accordance with the Internet Engineering Task Force (IETF) standard Real Time Control Protocol (RTCP). The RTCP can be implemented for this purpose in a respective connection endpoint.

Furthermore the registration unit can determine an origin ID unambiguously identifying the endpoint or an ID unambiguously identifying a connection partner of the endpoint, and send the origin ID or the connection partner ID with the received measurement data to a central QoS monitoring unit for evaluation. In this way endpoint-specific QoS profiles can be generated by the QoS monitoring unit. The central QoS monitoring unit can store the received measurement data in a database for subsequent evaluation, in particular statistical evaluation.

The connection endpoint can determine and collect the measurement data within a time interval of e.g. 3-5 seconds, and send it to the registration unit. The intervals at which current measurement data on the QoS is sent from the endpoint to the registration unit can preferably be set by the registration unit or the QoS monitoring unit. For monitoring a selected connection a shorter time interval, e.g. 1 second, can be set by administration before the connection is set up.

The registration unit and the QoS monitoring unit enable the QoS monitoring to be divided into logical layers. Thus the registration unit can compile a brief report, e.g. containing minimum, mean and maximum values of QoS parameters, in a CDR data record, in order to register the QoS perceived by the user. The CDR data record can then be retrieved by the QoS monitoring unit or by the postprocessing device or can serve as the basis for charge calculation procedures.

Optionally the QoS measurement data can be relayed from the registration unit to a QoS monitoring unit which is able to store large numbers of reports and to implement sophisticated statistics, graphs and functions. This type of QoS monitoring unit for instance enables call-specific QoS profiles or time-of-day statistics to be generated, QoS bottlenecks to be identified or online performance evaluations to be performed with an alarm when predefined thresholds are reached. In policy-based IP networks the QoS monitoring unit may interact with a policy manager of the network elements or directly with the network elements and for example adjust QoS profiles or time-of-day QoS profiles.

The invention can also be used on communication networks in accordance with the IETF standard Session Initiation Protocol (SIP). In communication networks of this type messages corresponding to the H.225-RAS messages ACF, IRR and DRQ for data transfer between endpoint and registration unit or between registration unit and QoS monitoring unit or central postprocessing device can be provided. In this way the messages can be enhanced, in the same way as the ACF, IRR and DRQ messages, with specific information elements for transportation of the measurement data. What is known as an authentication server or registrar can be used as a registration unit in an SIP communication system. This can forward QoS data records to a QoS monitoring unit or a central postprocessing device.

The invention can easily be adapted to different customer requirements on the basis of the advantageous division of QoS monitoring into endpoints, registration units and if necessary central postprocessing devices or QoS monitoring devices. Thus according to a low-end solution only per-call summary reports can be provided, and according to a high-end solution a sophisticated reporting procedure with a dedicated service management application and if necessary interaction with a policy-based network.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a VoIP communication network,

FIG. 2 is a timing diagram of a signaling procedure when initiating a QoS monitoring procedure,

FIG. 3 is a timing diagram of a signaling procedure when sending QoS measurement data to registration units,

FIG. 4 is a timing diagram of a signaling procedure when sending QoS data records to a central CDR postprocessing device, and

FIG. 5 is a timing diagram of a signaling procedure when sending QoS measurement data to a central QoS monitoring unit.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

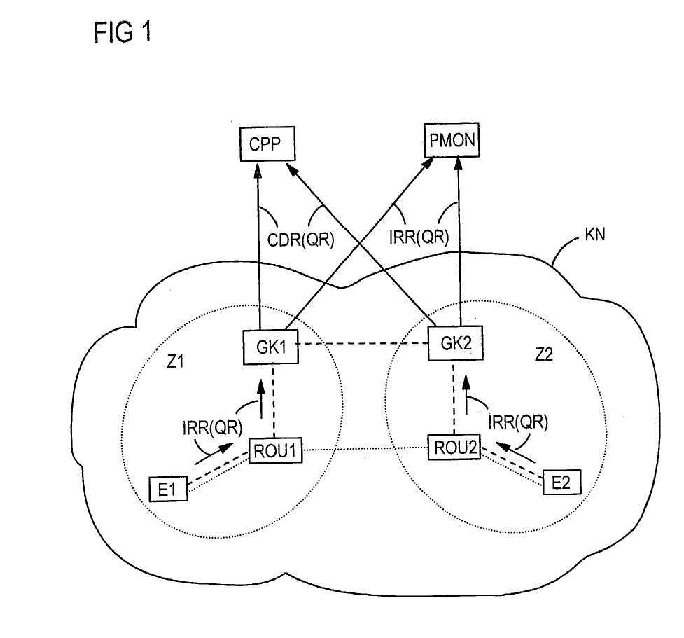

FIG. 1 is a block diagram of a VoIP communication network KN according to ITU-T Recommendation H.323 with a typical reference configuration for implementing a method according to the invention. The communication network KN includes two so-called gatekeeper zones Z1 and Z2. The gatekeeper zone Z1 here has a VoIP terminal E1, a router ROU1 and a gatekeeper GK1 according to the H.323 Recommendation as a registration unit, which is specifically responsible for connections with terminal devices, here E1, within the gatekeeper zone Z1. Similarly the gatekeeper zone Z2 has a VoIP terminal E2, a router ROU2 and a gatekeeper GK2 as a registration unit, which is specifically responsible for connections with terminal devices, here E2, within the gatekeeper zone Z2.

Furthermore a central CDR postprocessing device (CPP) and a central QoS monitoring unit, i.e., Performance Monitoring Unit (PMON), are assigned to the communication network KN. The CDR postprocessing device CPP is anyway used for processing CDR billing data records and according to the invention can be used for QoS monitoring connected at little extra expense. Compared to the CDR postprocessing device CPP, the QoS monitoring unit PMON used specifically for QoS monitoring permits a more detailed evaluation, analysis and monitoring of the QoS.

According to an alternative embodiment the communication network KN could be configured according to the SIP standard. In such a case, instead of the gatekeepers GK1 and GK2, SIP authentication servers or SIP registrars could be used as registration units.

In the following, setting up a VoIP connection between the terminals E1 and E2 is considered. An associated connection signaling takes place according to the H.323 Recommendation via the gatekeepers GK1 and GK2. In the present case the connection signaling runs, as indicated in FIG. 1 by dashed lines, from terminal E1 via router ROU1, gatekeeper GK1, gatekeeper GK2 and router ROU2 to terminal E2. This type of signaling management via gatekeepers is frequently also designated as a “gatekeeper routed model”. In the context of connection signaling, RAS messages (Registration Access Status) according to ITU-T Recommendation H.225 are exchanged between the terminal E1 and the gatekeeper GK1, and between the terminal E2 and the gatekeeper GK2.

As indicated in FIG. 1 by dotted lines, the user data to be sent in the context of the VoIP connection, such as any of voice, video and multimedia data, is switched by the routers ROU1 and ROU2 directly between the connection endpoints E1 and E2.

According to the invention the connection endpoints E1 and E2 record measurement data QR via different QoS parameters of the connection, such as any of end-to-end packet delay, jitter and packet losses, and are collected within a defined time interval of e.g. 3-5 seconds. The measurement data QR is recorded here on the basis of RTCP response information of an RTCP protocol (Real-Time Control Protocol) implemented in the terminals E1 and E2. The QoS measurement data QR collected by a respective terminal E1 or E2 is sent on expiration of a respective time interval within an RAS-IRR message IRR (Information Request Response) according to the H.225 Recommendation enhanced with a corresponding information element to the respective gatekeeper GK1 or GK2 responsible for the terminal E1 or E2.

The gatekeepers GK1 and GK2 can forward the received RAS-IRR messages IRR, if necessary enhanced by ID data, to the central QoS monitoring unit PMON.

Alternatively or additionally the gatekeepers GK1 and GK2 can process the QoS measurement data QR received with the RAS-IRR messages IRR to form a QoS data record, which is sent with CDR billing data record CDR enhanced with a QoS information element, to the CDR postprocessing device CPP. In this case the transfer can take place continuously or in batch mode. Until the CDR data records are sent a respective gatekeeper GK1 or GK2 can already undertake preprocessing of the QoS measurement data QR. The CDR data records CDR including the connection-specific QoS measurement data QR can be called from the CDR postprocessing device CPP. In addition, the CDR postprocessing device CPP can be used to generate simple QoS statistics.

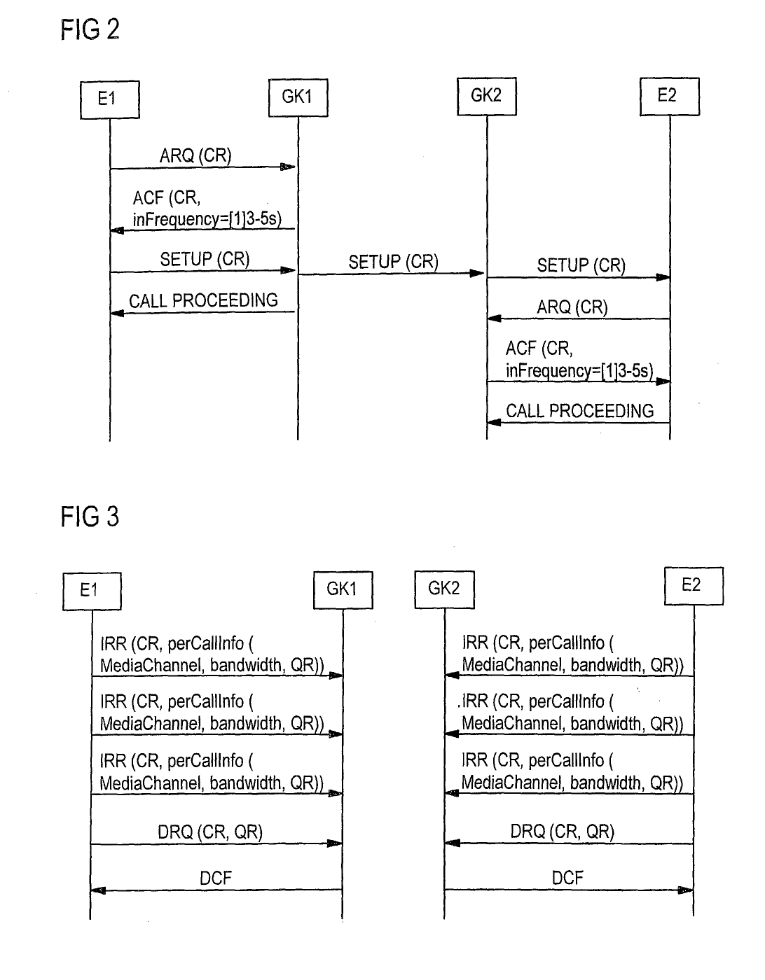

FIG. 2 shows a schematic representation of the signaling procedure when initiating a QoS monitoring process. To initialize the setup of the VoIP connection the terminal E1 sends an RAS-ARQ message ARQ (Admission Request) according to the H.225 Recommendation as an admission request message to the gatekeeper GK1, which in consequence returns an RAS-ACF message ACF (Admission Confirm) according to the H.225 Recommendation as an admission confirmation message to the terminal E1. Both messages contain what is known as a call reference value CR which assigns these messages to the VoIP connection to be set up.

Time information inFrequency is sent with the RAS-ACF message ACF to the terminal E1. The RAS-ACF message ACF prompts the terminal E1 to periodically send RAS-IRR messages IRR to the gatekeeper GK1, the time intervals at which the RAS-IRR messages IRR are to be sent being defined by the time information inFrequency. The length of the respective time interval at which the QoS measurement data QR is to be collected by the terminal E1 is thereby also predefined. The time intervals should preferably not be less than 3-5 seconds, in order not to significantly increase the network load. For measurements relating to individual connections, the time intervals can also be smaller, e.g. 500 ms—1 second.

On receipt of the RAS-ACF message ACF the terminal E1 sends a connection setup message SETUP with call reference value CR to the destination device E2 via the gatekeepers GK1 and GK2. This device then sends an RAS-ARQ message ARQ to the gatekeeper GK2, which responds with an RAS-ACF message ACF. Thanks to time information inFrequency contained in the RAS-ACF message ACF the terminal E2 is prompted, in the same way as the terminal E1, to periodically send RAS-IRR messages IRR to the gatekeeper GK2.

By returning a respective call proceeding message from the gatekeeper GK1 to the terminal E1 and from the terminal E2 to the gatekeeper GK2 the connection setup is continued.

FIG. 3 shows a schematic representation of the signaling procedure when sending the QoS measurement data QR to the gatekeepers GK1 and GK2. The QoS measurement data QR is sent at periodic intervals within the RAS-IRR messages IRR from the terminal E1 to the gatekeeper GK1 and from the terminal E2 to the gatekeeper GK2. The RAS-IRR messages IRR each contain, besides the call reference value CR, what is known as a perCallInfo information element, which includes media channel information MediaChannel, bandwidth information bandwidth and the respective QoS measurement data QR. The QoS measurement data QR preferably contains, among other things, minimum, average or maximum values of QoS parameters determined by the respective terminal E1 or E2 by receipt and evaluation of RTCP response messages during the monitoring time defined by the RAS-ACF messages ACF.

Finally, when tearing down the VoIP connection, concluding QoS measurement data records QR are sent over a last monitoring time within RAS-DRQ messages DRQ (Disengage Request) enhanced with a corresponding information element according to the H.225 Recommendation from the terminals E1 and E2 to the gatekeepers GK1 and GK2. The RAS-DRQ messages DRQ are in each case responded to by a Disengage Confirm message DCF.

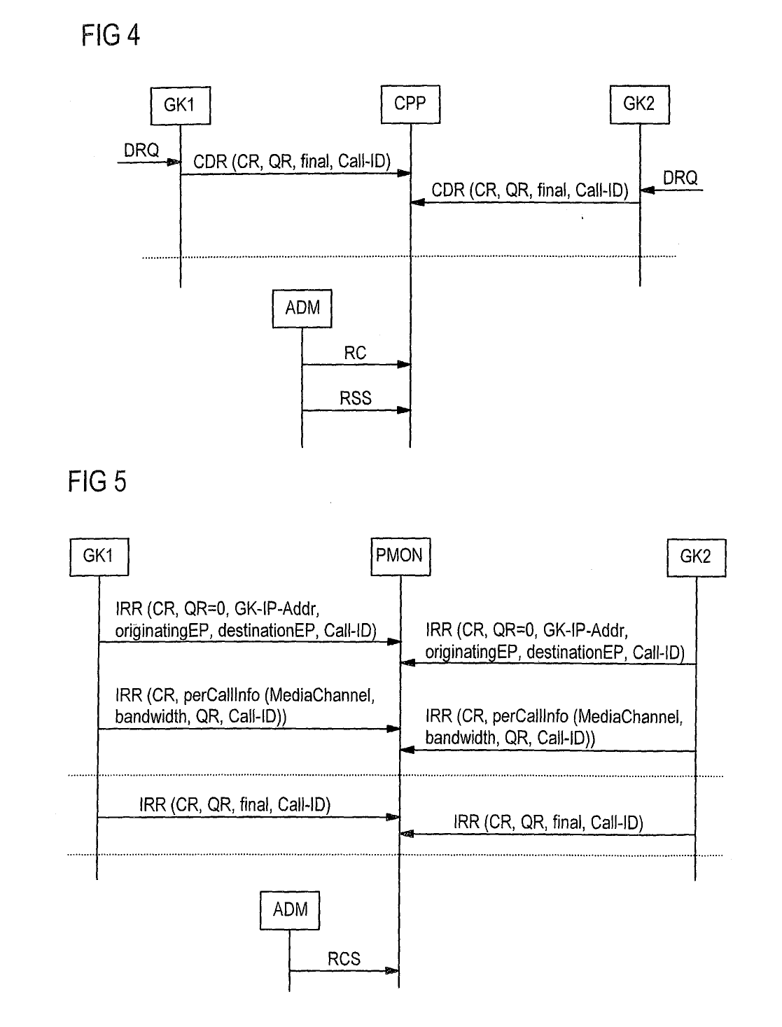

FIG. 4 shows a schematic representation of the signaling procedure when sending the CDR data records CDR to the central CDR postprocessing device CPP. The CDR data records CDR are sent by the gatekeepers GK1 and GK2 following each receipt of the RAS-DRQ message DRQ to the central CDR postprocessing device CPP. The CDR data records CDR each contain QoS measurement data QR, if necessary in the form of preprocessed QoS data records preprocessed by the gatekeeper GK1 or GK2, together with the call reference value CR, concluding information final and a call ID Call-ID. Based on the call ID Call-ID all received CDR data records CDR can be stored or postprocessed by the central CDR postprocessing device CPP on a connection-specific basis.

The CDR data records CDR collected by the CDR postprocessing device CPP for a number of VoIP connections can then be retrieved by an administration unit ADM e.g. by simple CDR retrieval messages RC. In addition, provision can also be made for simple QoS statistics to be read out by the administration unit ADM by differentiated readout messages RSS, the statistics being based on the collected QoS measurement data QR.

Finally, FIG. 5 shows a schematic representation of the signaling procedure when sending the QoS measurement data QR to the central QoS monitoring unit PMON. Thanks to the dedicated QoS monitoring unit PMON even very costly and time-consuming QoS monitoring functions can be made available.

The QoS measurement data QR received by the gatekeepers GK1 and GK2 is forwarded—after preprocessing if necessary—from the gatekeepers GK1 and GK2 within RAS-IRR messages IRR to the QoS monitoring unit PMON. In this connection a first RAS-IRR message IRR with a blank measurement data field (QR=0), the call reference value CR, the IP address GK-IP-Addr of the respective gatekeeper GK1 or GK2, an ID originatingEP of the connection endpoint E1 initiating the VoIP connection, an ID destinationEP of the connection destination E2 and the call ID Call-ID is initially sent in each case for initialization. The actual QoS measurement data QR is then sent within subsequent RAS-IRR messages IRR. These contain, besides the Call Reference Value CR, a perCallInfo information element containing media channel information MediaChannel, bandwidth information bandwidth and the QoS measurement data QR. When the VoIP connection is cleared down RAS-IRR messages IRR are finally sent with call reference value CR, concluding QoS measurement data records QR over a last monitoring time, concluding information final and the call ID Call-ID.

The QoS measurement data QR collected by the central QoS monitoring unit PMON for a number of VoIP connections can be processed by the QoS monitoring unit PMON to form complex statistics, such as QoS connection profiles, time-of-day profiles or network-topology-related profiles, or processed to form threshold definitions for alarms. The statistics produced can then be retrieved by an administration unit ADM by corresponding readout messages RCS.

On the basis of statistical information, such as topology and time-of-day profiles, interaction with policy managers or with policy management in network elements can be significantly improved. Thus network resources may be assigned to and adapted to the current traffic needs of multimedia network users virtually in realtime.

The invention has been described in detail with particular reference to preferred embodiments thereof and examples, but it will be understood that variations and modifications can be effected within the spirit and scope of the invention.

What is claimed is:

1. A method for monitoring quality of service in a packet-oriented network, comprising:
collecting measurement data on the quality of service of a connection by an endpoint of the connection within a given time interval; and
sending the measurement data for subsequent processing to a registration unit specifically responsible for connections with the endpoint.

2. A method according to claim 1, wherein said sending includes sending current measurement data on the quality of service at regular time intervals from the endpoint to the registration unit.

3. A method according to claim 2, wherein the regular time intervals are given by a Registration Access Status—Admission Confirm message sent to the endpoint in accordance with ITU-T Recommendation H.225.

4. A method according to claim 3, wherein the measurement data is sent within a Registration Access Status—Information Request Response message according to ITU-T Recommendation H.225 enhanced by a specific information element.

5. A method according to claim 4, further comprising when tearing down the connection, sending the measurement data within a Registration Access Status—Disengage Request message according to ITU-T Recommendation H.225 enhanced by a specific information element.

6. A method according to claim 5, further comprising:
processing in the registration unit the received measurement data to form a connection-specific quality of service data record; and
sending the quality of service data record to a central postprocessing device for evaluation.

7. A method according to claim 6, wherein the quality of service data record is sent with a billing data record, provided anyway for billing purposes, enhanced by a quality of service information element.

8. A method according to claim 7, wherein the billing data record is implemented by a call detail record.

9. A method according to claim 8, further comprising billing for the connection based on the billing data record dependent on the quality of service data record contained therein.

10. A method according to claim 9, wherein said collecting of the measurement data is in accordance with an Internet Engineering Task Force standard Real Time Control Protocol.

11. A method according to claim 10, further comprising:
determining in the registration unit an origin ID unambiguously identifying the endpoint in the network; and
sending the origin ID with the received measurement data to a central quality of service monitoring unit for evaluation.

12. A method according to claim 11, further comprising:
determining in the registration unit a connection partner ID unambiguously identifying a connection partner of the endpoint in the network; and
sending the connection partner ID with the measurement data to a central quality of service monitoring unit for evaluation.

13. A method according to claim 12, further comprising storing the measurement data by the central quality of service monitoring unit in a database for subsequent statistical evaluation.

14. At least one computer readable medium storing a program to control at least one processor to perform a method for monitoring quality of service in a packet-oriented network, comprising:
collecting measurement data on the quality of service of a connection by an endpoint of the connection within a given time interval; and
sending the measurement data for subsequent processing to a registration unit specifically responsible for connections with the endpoint.

15. A system for monitoring quality of service in a packet-oriented network, comprising:
an endpoint of a connection to collect measurement data on the quality of service of the connection within a given time interval and to send the measurement data for subsequent processing; and
a registration unit, specifically responsible for connections with the endpoint, to receive the measurement data.
